(19) United States
(12) Patent Application Publication
(10) Pub. No.: US 2024/0321031 A1
(43) Pub. Date: Sep. 26, 2024

(54) MEDIUM HANDLING DEVICE, MEDIUM HANDLING PROGRAM, AND MEDIUM RECOGNITION REFERENCE INFORMATION CREATION SYSTEM

(71) Applicant: Oki Electric Industry Co., Ltd., Tokyo (JP)

(72) Inventors: Hideki KOBORI, Tokyo (JP); Atsushi TAKADA, Tokyo (JP)

(73) Assignee: Oki Electric Industry Co., Ltd., Tokyo (JP)

(21) Appl. No.: 18/579,810

(22) PCT Filed: Jul. 19, 2022
(86) PCT No.: PCT/JP2022/028126

§ 371 Date: Jan. 16, 2024

(30) Foreign Application Priority Data
Oct. 7, 2021 (JP) 2021-165294

(51) Int. Cl. G07D 7/00; G07D 11/13

(52) U.S. Cl. CPC G07D 7/00; G07D 11/13; G07D 2207/00; G07D 2211/00

(57) ABSTRACT

A medium handling device includes a storage means that stores a single or plural medium recognition reference information, a recognition means that uses the medium recognition reference information to recognize a state of a target medium, and a setting means that, when medium recognition reference information that is new and authentication information corresponding to the new medium recognition reference information are stored in the storage means, sets use of the new medium recognition reference information as either valid or invalid. When the setting means has set valid, the recognition means uses the corresponding new medium recognition reference information to recognize a state of the medium.

### TECHNICAL FIELD

The present disclosure relates to a medium handling device, to a medium handling program, and to a medium recognition reference information creation system.

### BACKGROUND ART

For example, in a recognition and classification system of a banknote processing device, a master template for classifying a state of a banknote (hereafter also referred to as “medium recognition reference information”) is employed to perform note-type discrimination, soiling discrimination, damage discrimination, and the like on banknotes as the discrimination target.

Generally creation of a master template corresponding to the banknotes of each country is performed by a device vendor. On receiving an order, the device vendor as well as developing/improving a master template, also provides an evaluated master template to a partner side, such as a local agent or the like. The partner uses a recognition classification system installed with the master template to perform a demonstration or the like for a customer.

Moreover, technology is disclosed in Japanese Patent Application Laid-Open (JP-A) No. 2011-76244 (Patent Document 1) for facilitating updating of master templates. In the technology described in Patent Document 1, a banknote processing device detects characteristic information about the banknote using sensors, and sends the characteristic information to a host computer. The host computer uses the characteristic information to store the master template. Moreover, the master template stored in the host computer is one that is updated when necessary.

### SUMMARY OF INVENTION

### Technical Problem

However, creating a master template itself takes a long time due to needing to perform development/evaluation using a device vendor, and so it takes time until the master template is able to be supplied to the partner side.

For example, in cases in which the partner wants to operate the recognition classification system capable of handling a banknote with a new design to perform a demonstration to a customer as sales promotion activity, the partner has not been able to get the master template nor been able to operate the recognition classification system until development/evaluation by the device vendor has finished.

In consideration of the above circumstances, the present disclosure is configured so as to provide a medium handling device, a medium handling program, and a medium recognition reference information creation system capable of rapidly creating medium recognition reference information to recognize a medium, and capable of simple use of evaluated medium recognition reference information in a short period of time.

### Solution to Problem

In order to address these issues, a medium handling device of a first present disclosure includes a storage means that stores a single or plural medium recognition reference information, a recognition means that uses the medium recognition reference information to recognize a state of a target medium, and a setting means that, when medium recognition reference information that is new and authentication information corresponding to the new medium recognition reference information are stored in the storage means, sets use of the new medium recognition reference information as either valid or invalid. When the setting means has set valid, the recognition means uses the corresponding new medium recognition reference information to recognize a state of the medium.

A medium handling device of a second present disclosure includes a storage means that stores a single or plural medium recognition reference information, a recognition means that uses the medium recognition reference information to recognize a state of a target medium, and a setting means that, when medium recognition reference information that is new is stored in the storage means, sets use of the new medium recognition reference information as either valid or invalid. When the setting means has set valid, the recognition means uses the corresponding new medium recognition reference information to recognize a state of the medium.

A medium handling program of a third present disclosure causes a computer provided with a storage means that stores a single or plural medium recognition reference information to function as a recognition means that uses the medium recognition reference information to recognize a state of a target medium, and a setting means that, when medium recognition reference information that is new and authentication information corresponding to the new medium recognition reference information are stored in the storage means, sets use of the new medium recognition reference information as either valid or invalid. When the setting means has set valid, the recognition means uses the corresponding new medium recognition reference information to recognize a state of the medium.

A medium handling program of a fourth present disclosure causes a computer provided with a storage means that stores a single or plural medium recognition reference information to function as a recognition means that uses the medium recognition reference information to recognize a state of a target medium, and a setting means that, when medium recognition reference information that is new is stored in the storage means, sets use of the new medium recognition reference information as either valid or invalid. When the setting means has set valid, the recognition means uses the corresponding new medium recognition reference information to recognize a state of the medium.

A medium recognition reference information creation system of a fifth present disclosure includes a first system including a first medium handling device and a reference information generation device, and a second system that is separate to the first system and that includes a second medium handling device and an authentication device. The reference information generation device of the first system detects characteristic information about introduced medium and generates medium recognition reference information for the medium. The second medium handling device of the second system uses the medium recognition reference information generated by the reference information generation device and the medium characteristic information to evaluate a quality of the medium recognition reference information. The authentication device of the second system generates authentication information corresponding to the medium recognition reference information evaluated by the second medium handling device. The first medium handling device of the first system includes a storage means that stores a single or plural medium recognition reference information, a recognition means that uses the medium recognition reference information to recognize a state of a target medium, and a setting means that, when new medium recognition reference information that has been evaluated by the second medium handling device and authentication information corresponding to the new medium recognition reference information are stored in the storage means, sets use of the new medium recognition reference information as either valid or invalid. When the setting means has set valid, the recognition means uses the corresponding new medium recognition reference information to recognize a state of the medium.

### Advantageous Effects

The present disclosure enables rapid creation of medium recognition reference information for recognizing a medium, and enables an evaluated medium recognition reference information to be used simply in a short period of time.

### BRIEF DESCRIPTION OF DRAWINGS

FIG. 1 is an overall configuration diagram illustrating an overall configuration of a classification processing system according to a first exemplary embodiment.

FIG. 2 is an internal configuration diagram for explaining an internal configuration of a banknote processing device of the first exemplary embodiment.

FIG. 3 is a block diagram illustrating a configuration of a control system of a classification device according to the first exemplary embodiment.

FIG. 4 explains overall processing of the classification processing system according to the first exemplary embodiment.

FIG. 5 is a flowchart illustrating an operation of pay-in processing in a banknote processing device according to the first exemplary embodiment.

FIG. 6 is an overall configuration diagram illustrating an overall configuration of a classification processing system according to a second exemplary embodiment.

FIG. 7 explains overall processing of the classification processing system according to the second exemplary embodiment.

FIG. 8 is a flowchart illustrating an operation of pay-in processing in a cash processing device according to the second exemplary embodiment.

### DESCRIPTION OF EMBODIMENTS

### (A) First Exemplary Embodiment

Description follows regarding a first exemplary embodiment of a medium handling device, a medium handling program, a medium handling program, and a medium recognition reference information creation system according to the present disclosure, with reference to the drawings.

The first exemplary embodiment is an example in which the medium handling device of the present disclosure is applied to a banknote processing device such as an automated teller machine (ATM) or the like utilized in a financial institution or the like.

“Medium” is a paper medium with a monetary value and encompasses, for example, banknotes, gift certificate, securities, and the like.

### (A-1) First Exemplary Embodiment Configuration

### (A-1-1) Overall Configuration

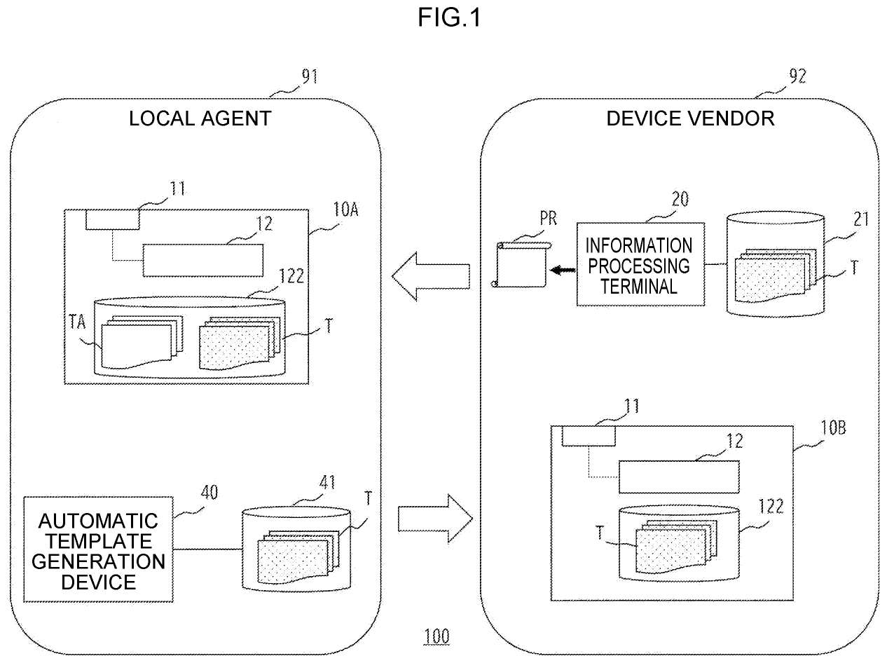

FIG. 1 is an overall configuration diagram illustrating an overall configuration of a classification processing system according to an exemplary embodiment.

In FIG. 1, the classification processing system 100 according to the present exemplary embodiment is broadly divided into a local agent side system 91 serving as a partner, and a device vendor side system 92 of a device vendor of a banknote processing device 10 (10A, 10B).

A master template employed for classifying new banknotes is denoted “master template T”. A master template existing from the beginning in the classification device 12, or a master template existing prior to installing the new master template T, is denoted “master template TA”.

In this exemplary embodiment, in order to facilitate explanation, a device vendor manufactures the banknote processing device 10 in a first country. Moreover, suppose a local agent sells the banknote processing device 10 of the device vendor in a second country (a country different to the first country). Note that the classification processing system 100 of the exemplary embodiment may be in the same country as the country where the device vendor is located or the sales country of the agent.

This exemplary embodiment is an example of a utilization mode as described below. In the second country, a master template T is created on the local agent side where a novel banknote (new banknote) with a new design might be handled. In the first country, the device vendor side verifies a quality (reliability) of the master template T created by the local agent. In cases in which the result thereof is that the device vendor side assures the quality, the device vendor side issues an authentication certificate PR corresponding to the master template T, and the device vendor side enables installation to the banknote processing device 10A. The local agent side installs the above authentication certificate PR in the banknote processing device 10A, and the banknote processing device 10A performs a demonstration of new banknote classification processing employing the new master template T.

Note that the utilization mode is not limited to this exemplary embodiment. Various utilization modes are applicable as long as they are utilization modes that enable an earlier time than hitherto for a time from when a master template T is created and from when a new banknote might be handled until starting a test.

Furthermore, in cases in which the presence of an authentication certificate PR associated with the master template T has been confirmed, highly accurate classification processing may be performed using the master template T, and classification processing may be performed at higher classification speed, conveyance speed, and the like.

The device vendor is a manufacturing supplier who develops/manufactures/sells the banknote processing device 10 (10A, 10B) corresponding to a banknote of a second country. The device vendor develops/improves the master template T of a classification device 12 installed to the banknote processing device 10, and furthermore evaluates the quality of the master template T.

This master template T is reference information (for example, reference values, reference images, reference data, and the like) for classifying a state of a banknote passing through the classification device 12. There are various types of classification executed by the classification device 12. This classification type envisages a classification type capable of showing a customer the working of the banknote processing device 10 in a demonstration or the like. For example, the classification type may be note-type discrimination, soiling discrimination, damage discrimination, or the like, and the master template T is one utilized in the note-type discrimination, soiling discrimination, damage discrimination, or the like. Obviously soiling discrimination, damage discrimination, and note-type discrimination are merely single types, and application may be made to a master template T capable of corresponding to other types of damage discrimination. Note that, depending on the application of the master template, the master template T may, for example, initially be a template directed toward note-type discrimination alone, and then afterwards a template directed toward soiling discrimination or the like may be added, as required.

For example in camera images, the master template T for note-type discrimination may be an image (camera image) including characteristic information for each type of banknote. A master template T for note-type discrimination is needed for each type of banknote. The characteristic information may, for example, be information including numerical characters and motifs that appear on a banknote, and the positions, sizes, ranges and the like of the numerical characters and motifs. In cases in which a particular treatment has been performed, the characteristic information may be configured to include information for confirming this particular treatment.

For example, the master template T of the soiling discrimination is a reference value related to a level of soiling of the banknote in the camera image for rejecting a soiled banknote. For example, the reference value of soiling discrimination is used as a value to indicate a proportion in the banknote area of an area able to be identified as being soiled. Thus the banknote can be determined to be soiled when the proportion in the banknote area of the area identified as being soiled is the reference value or greater, and the banknote can be determined to not be soiled when the proportion is less than the reference value.

For example, the damage discrimination master template T is a reference value related to a level of damage, adhered tape, or the like in the camera image for rejecting a damaged banknote. For example, the damage discrimination reference value is used as a value to indicate a damage length, proportion of damage area in the banknote area. Thus, for example, the banknote can be determined to be damaged when the length of damage in the banknote area is determined to be the reference value or greater, and the banknote can be determined as not being damaged when the length is less than the reference value.

Note that the master template T is not limited to the above example and, for example, may be configured so as to include a master template used for authenticity discrimination, sway discrimination (detecting a banknote conveyed at an angle), double feeding discrimination, and the like.

### Local Agent Side System 91

The local agent side system 91 includes a banknote processing device 10A installed with the classification device 12, and an automatic template generation device 40.

The automatic template generation device 40 receives introduction of banknotes of the second country under operation of an operator at the local agent, detects the state of each banknote, and stores information indicating the state of each banknote in a storage section 41. The automatic template generation device 40 generates a master template T based on the stored information indicating the state of each banknote. The automatic template generation device 40 generates a denomination specific master template T for each of the denominations according to the type of master template T.

The automatic template generation device 40 may, for example, be a dedicated device equipped with a banknote pay-in/pay-out section, classification section, conveyance path, and the like, or may be an automatic template generation program (application software program). In cases in which the automatic template generation device 40 is an automatic template generation program, software may, for example, be installed to the existing banknote processing device 10 or classification device 12, and the master template T may be created using existing hardware.

The automatic template generation device 40 is widely applicable to various existing devices or existing application software programs. For example, the automatic template generation device 40 may be configured so as to perform statistical analysis processing employing information indicating states of a large volume of banknotes. Moreover, for example, the automatic template generation device 40 may be a device into which a large number of banknote is introduced, and that generates a master template T by performing machine learning using information indicating states of a large volume of banknotes. There are no particular limitations to a machine learning algorithm thereof, and a neural network or the like may be employed.

This master template T is transmitted to the device vendor side in a high security environment so as to avoid forgery or the like of the new banknote. The information indicating banknote states used to create the master template T is also transmitted to the device vendor side so as to enable utilization in the evaluation of the master template T. Various methods may be employed as long as there is a high security environment and, for example, transmission to the device vendor side may be with a high security communication protocol by performing encryption processing or the like. Note that in cases in which a communication interface is installed to the automatic template generation device 40, this communication interface transmits the master template T and information indicating the banknote states to the device vendor side. Moreover, for example, a terminal provided with a communication function, such as a personal computer or the like, may be employed for transmission to the device vendor side.

The banknote processing device 10A is a device that the local agent side is trying to sell to a customer. Namely, the banknote processing device 10A has been developed and manufactured by the device vendor side. The banknote processing device 10A is basically the same as a banknote processing device 10B on the device vendor side.

The banknote processing device 10A is installable with an authentication certificate PR acquired from the device vendor side. The banknote processing device 10A is able to perform valid classification processing using the master template T when the presence of an authentication certificate PR is confirmed, and is not able to perform valid classification processing using a master template T when the presence of an authentication certificate PR is not confirmed. Note that detailed explanation of the processing of the banknote processing device 10A according to whether or not there is an authentication certificate PR is given in detail under the heading of operation.

### Device Vendor Side System 92

The device vendor side system 92 includes a banknote processing device 10B installed with the classification device 12, and an information processing terminal 20.

The banknote processing device 10B is a device to develop, improve, and evaluate master templates T on the device vendor side. The banknote processing device 10B is basically the same as the banknote processing device 10A on the local agent side. The banknote processing device 10B installs the master template T generated by the local agent side so to be utilizable by the classification device 12, and the classification device 12 performs classification processing using information indicating the banknote state as acquired from the local agent side. The classification result is evaluated on the device vendor side.

The banknote processing device 10B is able to correct values of the master template T by operation on the device vendor side. The banknote processing device 10B performs repeated classification processing using the master template T after correction.

The information processing terminal 20 is, for example, an information processing device such as a personal computer or the like. The information processing terminal 20 stores the master template T evaluated for quality on the device vendor side in a template database 21. The information processing terminal 20 is a terminal that issues an authentication certificate PR corresponding to the master template T.

The authentication certificate PR corresponding to the master template T is transmitted to the local agent side in a high security environment. For example, the communication interface of the information processing terminal 20 transmits the authentication certificate PR corresponding to the master template T to the device vendor side with a high security communication protocol by performing encryption processing or the like thereon.

### (A-1-2) Banknote Processing Device 10 Configuration

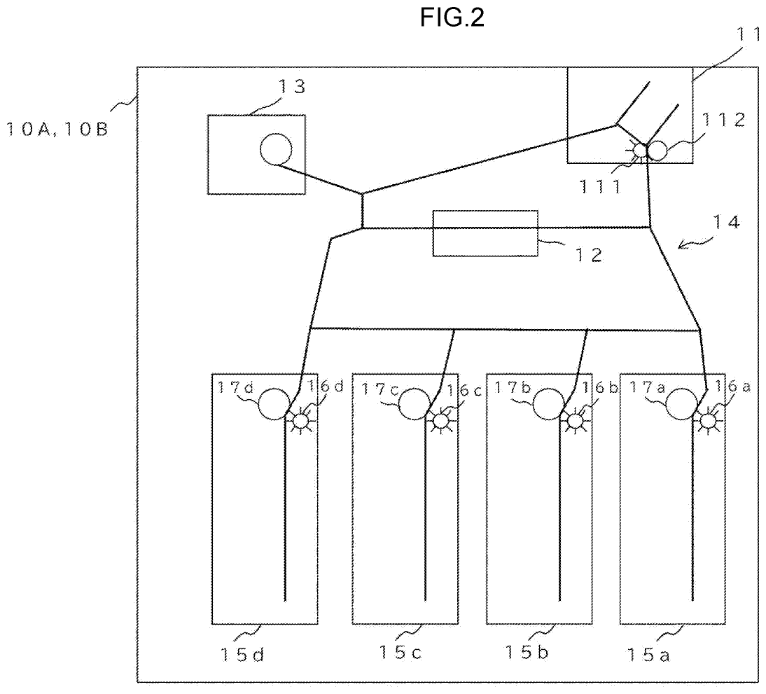

FIG. 2 is an internal configuration diagram to explain the internal configuration of the banknote processing device 10 of the exemplary embodiment.

The banknote processing device 10 in FIG. 2 includes a banknote pay-in/pay-out section 11, the classification device 12 that discriminates the state of the banknotes passing along a conveyance section 14, a temporary holding section 13 that temporarily stores banknotes, the conveyance section 14 that conveys banknotes to each section, and plural banknote storage boxes 15a to 15d that store banknotes.

Note that although not illustrated, the banknote processing device 10 includes a central processing unit (CPU), read only memory (ROM), random access memory (RAM), and a storage section such as a hard disk drive, flash memory, or the like. The CPU performs various transaction processing and the like, such as pay-in transactions and pay-out transactions, by reading and executing a processing program stored in the ROM. Moreover, the banknote processing device 10 includes a non-illustrated display section and operation section, and the CPU displays, for example, a screen indicating an operational state, a confirmation result screen, classification results, and the like on the display section.

The conveyance section 14 is a part to convey banknotes between each configuration element of the banknote processing device 10, and includes plural conveyance rollers needed for conveying banknotes. For example, conveyance rollers are disposed so as to oppose each other across the conveyance path of the conveyance section 14, and transmit drive force to the banknotes by rotating. The conveyance section 14 is configured with switching blades disposed at branch points, and the switching blades switch the conveyance destinations of the banknotes. The conveyance section 14 includes sensors disposed at intervals as appropriate, and the sensors detect the conveyance state of the banknotes.

The banknote pay-in/pay-out section 11 is a functional section that receives introduced banknotes, or stacks banknotes for paying out to a customer. The banknote pay-in/pay-out section 11 includes a separation means (for example a separation roller configuration) 111 and 112 to separate introduced banknotes and feed them out one-by-one to the conveyance section 14.

The temporary holding section 13 is a part that temporarily stacks banknotes arriving via the conveyance section 14 and holds the banknotes. Various structures are applicable for the structure of the temporary holding section 13 and, for example, a tape method may be applied therefor to store the banknotes by wrapping the banknotes around a drum together with a tape.

The banknote storage boxes 15a to 15d are medium storage boxes for storing banknotes by denomination. For example, the banknote storage boxes 15a to 15d each include a separation means 16 and 17 such as separation rollers for example, and are recirculation recycling cassettes that store paid-in banknotes during paying in, and then pay out the stored banknotes during paying out. Note that the number of individual banknote storage boxes 15a to 15d is not particularly limited, and the usage of the banknote storage boxes 15a to 15d may also be determined as appropriate according to operation.

The classification device 12 performs classification, count processing, serial number identification processing, and the like on the banknotes conveyed by the conveyance section 14. The classification device 12, for example, includes a group of sensors, such as optical sensors and magnetic sensors, recognizes the state of passing banknotes, and performs condition determination (determination as being a soiled note, a damaged note, a destroyed note, an abnormal external profile note, a folded note, or the like, or determination as being a normal note), denomination determination, count processing, and the like. The classification device 12 may also be configured so as to perform banknote authenticity determination (determination of being a genuine note, a forged note, or the like).

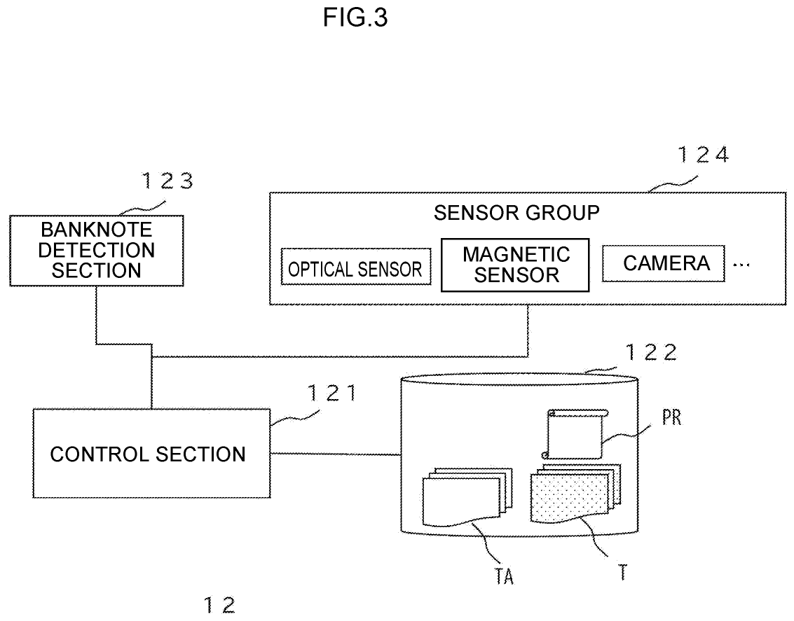

FIG. 3 is a block diagram illustrating a configuration of a control system of the classification device 12 according to the exemplary embodiment.

The classification device 12 of FIG. 3 includes a control section 121, a storage section 122, a banknote detection section 123, and a sensor group 124.

The control section 121 is employed to manage processing of the classification device 12.

The storage section 122 stores previously provided master templates TA, the new master template T, a processing program related to classification, data needed for classification, classification results, and the like.

The banknote detection section 123 detects banknotes being conveyed by the conveyance section 14, and when a banknote has been detected notifies the control section 121 that the banknote has been detected. For example, the banknote detection section 123 may employ optical sensors including light transmitters and photoreceptors installed across the conveyance section 14. The photoreceptors notify the control section 121 with an ON signal indicating that no banknote is detected when visible light is received from the light transmitters. The photoreceptors notify the control section 121 with an OFF signal indicating that a banknote has been detected when a banknote passes through the conveyance section 14 and the photoreceptors are not able to receive visible light from the light transmitters. Note that the banknote detection section 123 is not limited to the above example, and another detection method is applicable therefor.

The sensor group 124 is a sensor group to detect the state of passing banknotes. The sensor group is equipped not only with one type of sensor but with plural types of sensor for performing banknote classification. The sensor group includes, for example, optical sensors such as a light transmitter, reception device, and the like, magnetic sensors, a camera such as a CCD camera or the like, with these being installed above and below the conveyance path.

### (A-2) First Exemplary Embodiment Operation

Next description follows regarding processing of the classification processing system 100 according to the first exemplary embodiment, with reference to the drawings.

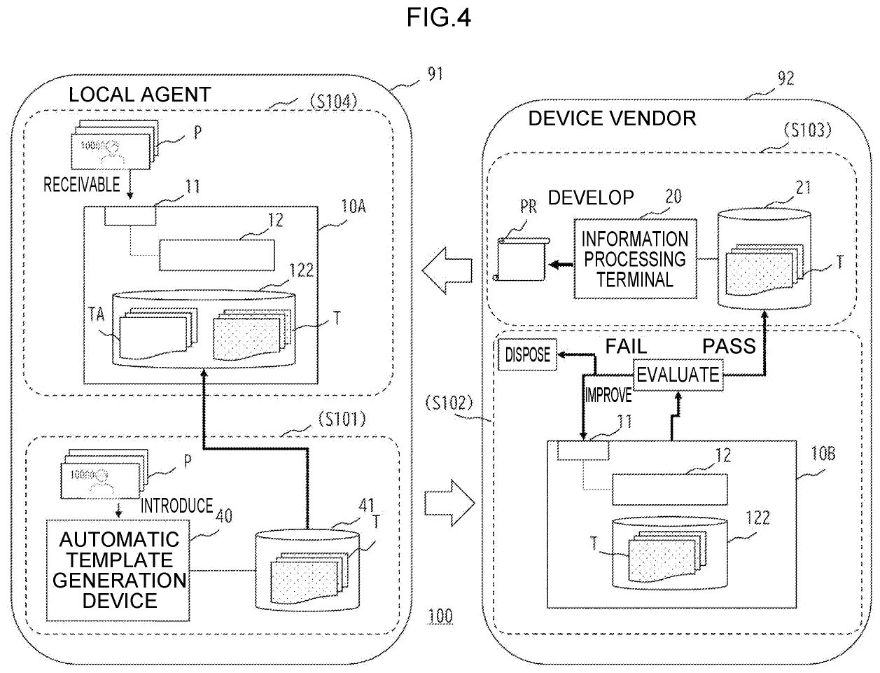

FIG. 4 is for explaining the overall processing of the classification processing system 100 according to the first exemplary embodiment.

### S101: Master Template T Creation

First in the local agent side system 91, a master template T is created by the automatic template generation device 40 for use in classification of banknotes P of the second country.

Suppose that the local agent side has banknotes P (second country banknote) for which they wish to add a master template T. Suppose that he local agent side is able to get hold of the banknotes P and the banknotes P are able to be handled on the local agent side.

The banknotes P are introduced to the automatic template generation device 40 at the local agent side system 91 by an operator on the local agent side. The automatic template generation device 40 detects the states of the introduced banknotes P, and stores information indicating the banknote states in the storage section 41. When doing so, in order to raise the precision of the master template T being generated, a large number of the banknotes P are introduced to the automatic template generation device 40, and information indicating the banknote states for a large volume of banknotes P is held in the storage section 41.

The automatic template generation device 40 employs information indicating the banknote states stored in the storage section 41 and generates the master template T for the banknote P.

Note that various existing methods may be widely applied as the method of generating the template, and although detailed explanation thereof is omitted here, these are some examples.

For example, in cases in which a master template T is being generated for soiling discrimination, image information for a large number of banknotes P having different levels of soiling is stored in the storage section 41. The banknotes P include banknotes that have previously been decided should be rejected and banknotes that have previously been decided should not be rejected. The automatic template generation device 40 detects soiled areas based on image information of the banknotes P. The automatic template generation device 40 finds a soiled area proportion value indicating the proportion of area soiled in the banknote area for each of the banknotes, and furthermore associates information indicating whether or not the banknote should be rejected (for example, a flag) with the soiled area proportion value for each banknote. The automatic template generation device 40 performs statistical processing using a large volume of the soiled area proportion values described above. For example, the automatic template generation device 40 finds a value obtained by normalizing the soiled area proportion values of reject banknotes, and employs this as a reference value in the master template T. The method of generating the master templates T is not limited to that described above, and another method is applicable therefor. Moreover, an appropriate method may be employed according to the type of classification.

The master template T generated by the automatic template generation device 40 is subjected to high security processing and transmitted to the device vendor side system 92.

In order to confirm the quality of the master template T, the master template T may be installed in the banknote processing device 10A such that the master template T is utilizable by the classification device 12 of the banknote processing device 10A, and a quality test performed on the master template T. Namely, reject banknotes and normal banknotes are recognized, and a large number of the banknotes P are introduced into the banknote processing device 10A, the classification device 12 performs successive classification thereof using the master template T, and the classification result is checked as to whether or not it is “normal”. The master template T may be transmitted to the device vendor side when the quality of the master template T in the classification result is at a good level.

### S102: Master Template T Evaluation

In order to evaluate the master template T generated at the local agent side in the device vendor side system 92, the master template T is installed to the banknote processing device 10B.

Furthermore, information indicating the state of banknotes utilized to generate the above master template T is also stored in the storage section 122 readable by the banknote processing device 10B.

In the banknote processing device 10B, the information indicating the banknote states is input successively into the classification device 12, the classification device 12 performs the classification processing using the master template T, and the classification result is stored in the storage section 122.

An operator on the device vendor side evaluates the quality of the master template T while comparing the classification result of the classification device 12 using the master template T against information indicating the state of utilized banknotes.

In cases in which the quality is evaluated as good, namely, in cases in which the master template T is an acceptable product, this master template T is saved in the template database 21.

On the other hand, when the quality is evaluated as not good and the master template T has been determined to be a reject product, then the reference values serving as thresholds are corrected by the banknote processing device 10B to improve the master template T. Then when the information indicating banknote states is again introduced to the classification device 12, and the classification device 12 performs classification processing using the corrected master template T.

Improvement of the master template T is performed in this manner, and the master template T after improvement is saved in the template database 21 when quality is evaluated as good.

On the other hand, the master template T and the improved version thereof are discarded in cases in which the quality is not evaluated as good even though the master template T has been improved.

### S103: Authentication Certificate Pr Issue

In the device vendor side system 92, an authentication certificate PR corresponding to the master template T saved in the template database 21 is issued by the information processing terminal 20.

The authentication certificate PR is information to assure the quality of the master template T. The authentication certificate PR is associated with the master template T. For example, the authentication certificate PR may be configured with file information to identify the master template T, such as a name of the country of the banknotes P, a series number to discriminate a template issue year, a note-type, or the like. Moreover, as a separate modified example, for example, the authentication certificate PR may be encrypted with an encryption method such as a public key method or the like in order to make the master template T useable.

After the authentication certificate PR corresponding to the master template T has been issued, the information processing terminal 20 transmits information including the authentication certificate PR to the local agent side.

When the master template T has been improved, the post-improvement master template T may be included in the same file as the authentication certificate PR, and may be transmitted therewith to the local agent side. There is not particular limitation to the method of notifying information including the authentication certificate PR, and various methods are widely applicable therefor as long as they are methods that preserve security.

### S104: Transaction Processing Using Master Template T

In the banknote processing device 10A, when the authentication certificate PR is installed and transaction processing is to be performed, the control section 121 of the classification device 12 performs classification processing to confirm whether or not there is an authentication certificate PR.

Then in cases in which the authentication certificate PR has been confirmed, the control section 121 operates as a device installed with a new master template T. For example, a local agent or customer is able to receive an assurance of maintenance support of the device vendor by the local agent or customer paying the device vendor an authentication fee.

However, in cases in which an authentication certificate PR is not confirmed, the control section 121 operates as a device in a state in which the new master template T is not installed. For example, although basic easy operation such as demonstration or the like is possible without assurance from the device vendor, support is not able to be received during a malfunction.

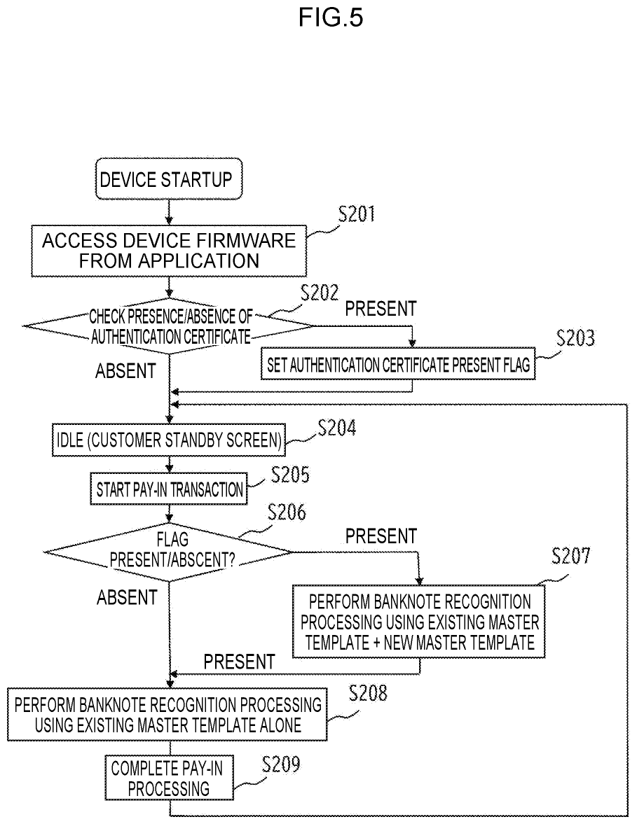

Description follows regarding an example of an operation to confirm the authentication certificate PR when a pay-in transaction is being performed in the banknote processing device 10A, and to perform classification processing using the master template T, with reference to FIG. 5.

FIG. 5 is a flowchart illustrating an operation of pay-in processing in the banknote processing device 10A according to the first exemplary embodiment.

Note that although an example is given here in which the classification device 12 performs classification processing using the master template T while pay-in processing is being performed, the transaction processing is no limited thereto, and is also applicable to pay-out processing, wire transfer processing, and the like.

As described above, in the device vendor side system 92, when the quality of the new master template T has passed evaluation, the information processing terminal 20 issues the authentication certificate PR corresponding to this master template T.

The file of the authentication certificate PR is saved on the hard disk of the banknote processing device 10A (in this example in the storage section 122).

For example, in cases in which the local agent side performs a demonstration of the banknote processing device 10A to a customer either before the banknotes P are in circulation or at the earliest possible stage after the banknotes P are in circulation, the local agent side is able to download an application related to banknote processing (hereafter referred to as “device application”) and install it in the banknote processing device 10A, and a file of the authentication certificate PR is also installed at the same time. Moreover, for example, a file of the authentication certificate PR is installed to the banknote processing device 10A at product shipment when selling the banknote processing device 10A.

In FIG. 5, after device startup of the banknote processing device 10A, the device application accesses firmware of the device (S201), and the device application checks whether or not a file of an authentication certificate PR is saved on the storage section (hard disk) 122 (S202).

In cases in which there is a file of an authentication certificate PR, the device application sets a new template flag indicating use of the quality-authenticated new master template is valid (S203), and then processing transitions to S204.

For example, the new template flag may be represented by information of one bit or plural bits, and when the new template flag is “1” this means use of the new master template T is valid. On the other, when the new template flag indicating “O” then this means use of the new master template T is invalid.

Processing transitions to S204 when there is no authentication certificate PR file.

At S204, as an idle state of the device application, the device application displays a customer standby reception screen on the display section, such as a display or the like, of the banknote processing device 10A (S204).

At S205, when a pay-in transaction is started (S205), the device application determines whether or not the new template flag is set (S206).

In cases in which the new template flag is set, the classification device 12 performs classification processing using the new master template T and the existing master template TA (S207). On the other hand, in cases in which the new template flag has not been set, the classification device 12 performs classification processing using the existing master template TA (S208).

Then when the pay-in transaction has been completed (S209), the processing transitions to S204 and returns to the idle state.

Description follows regarding modified examples. The example of FIG. 5 is an example of a case in which the authentication certificate PR file is saved on a hard disk (the storage section 122), however the authentication certificate PR file may be saved in non-volatile memory on a BRM substrate at the same time as the device application.

Moreover, although there is no illustration of an authentication certificate PR file corresponding to an existing master template TA, an authentication certificate PR may also be saved for an existing master template TA. Namely, the banknote processing device 10A may be configured so as to be able to set an authentication certificate PR and a template flag one-for-one for each of the master templates. Then the corresponding master template is able to be used when the authentication certificate PR and the flag are set.

Furthermore, an encryption key (public key) to enable use of the master template may be employed instead of the new template flag.

### (A-3) First Exemplary Embodiment Advantageous Effects

As described above, the first exemplary embodiment enables execution of a demo operation in a short period of time by introducing foreign banknotes or the like that are newly desired to be handled and automatically generating a new template.

The local agent transmits the new template to the device vendor, the device vendor issues an authentication certificate file for passing evaluation, and the local agent installs the authentication certificate file in the banknote processing device. The banknote processing device of the local agent thereby becomes a device assured by the device vendor. By doing so, a demo operation of foreign banknotes that are newly desired to be handled is executed early, enabling promotional activity toward customers to take place. The device vendor side is also able to make clear what is covered by assurance by the presence or absence of the authentication certificate file.

### (B) Second Exemplary Embodiment

Next description follows regarding a second exemplary embodiment of a medium handling device, a medium handling program, a medium handling program, and a medium recognition reference information creation system according to the present disclosure, with reference to the drawings.

The second exemplary embodiment is an example for a case in which the present disclosure is applied to, for example, a cash processing device that performs sales money processing and pay-in/pay-out processing at a retailer.

### (B-1) Second Exemplary Embodiment Configuration

For example, sometimes gift certificates (coupons) are issued that have usage limited to only a given region. Moreover, although gift certificates have various validity periods, and there are also sometimes gift certificates with a limited validity period. Gift certificates are sometimes issued/distributed for a short period of time, with a rapid response thereto demanded in a store such as a retailer or the like.

However, for cash processing devices installed in a retailer or the like, the device vendor side thereof incurs both a cost and an operational burden to providing a cash processing machine compatible with a gift certificate having a limited region or limited validity period at a short lead time.

Thus there is a demand for a cash processing device capable of rapidly responding at a retailer or the like, even for cases in which a new gift certificate has been issued.

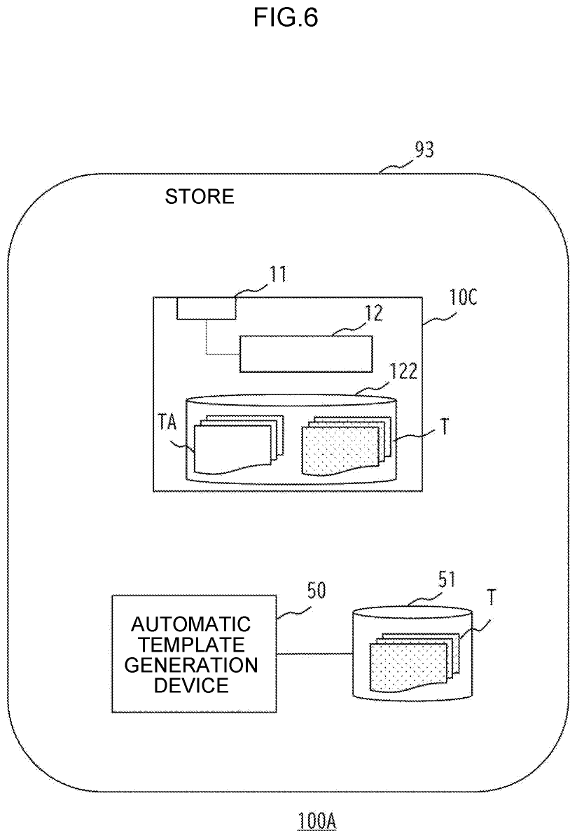

FIG. 6 is an overall configuration diagram illustrating an overall configuration of a classification processing system according to the second exemplary embodiment.

In FIG. 6, a classification processing system 100A is a system in a store 93, and the classification processing system 100A includes a cash processing device 10C installed with a classification device 12, and an automatic template generation device 50.

The automatic template generation device 50 receives introduced gift certificates Q, detects characteristic information of the gift certificates Q, and stores the characteristic information of the gift certificates Q in a storage section 51. The automatic template generation device 50 generates a master template T based on the characteristic information of the gift certificates Q.

For example, the automatic template generation device 50 may be a dedicated device, or may be an automatic template generation program (application software program). In the latter case, for example, software may be installed to the cash processing device 10C or the classification device 12, and a master template T may be created using hardware of the cash processing device 10C or the classification device 12.

Note that, similarly to in the first exemplary embodiment, various methods are widely applicable as the method of generating the master template T. For example, the automatic template generation device 50 may employ a method to acquire characteristic information, such as a note-type, design, validity period, usage region, and the like of the gift certificates Q, based on the characteristic information of the gift certificate Q. Moreover, for example, the automatic template generation device 50 may be a device that generates the master template T by performing machine learning on the characteristic information of the gift certificate Q. There are no particular limitations to a machine learning algorithm thereof and, for example, a neural network or the like may be employed therefor.

The cash processing device 10C is a cash processing machine installed in a store for performing processing such as sales money processing and pay-in/pay-out processing at the retailer. The cash processing device 10C saves a master template T corresponding to a new gift certificate Q, and performs recognition processing on the gift certificates Q using the master template T. The cash processing device 10C saves the master template T, and sets a new template flag.

The cash processing device 10C then enables recognition processing to be performed on the gift certificate Q using the master template T when the new template flag has been set. Moreover, the cash processing device 10C does not enable use of the master template T of the gift certificate Q when the new template flag has not been set.

### (B-2) Second Exemplary Embodiment Operation

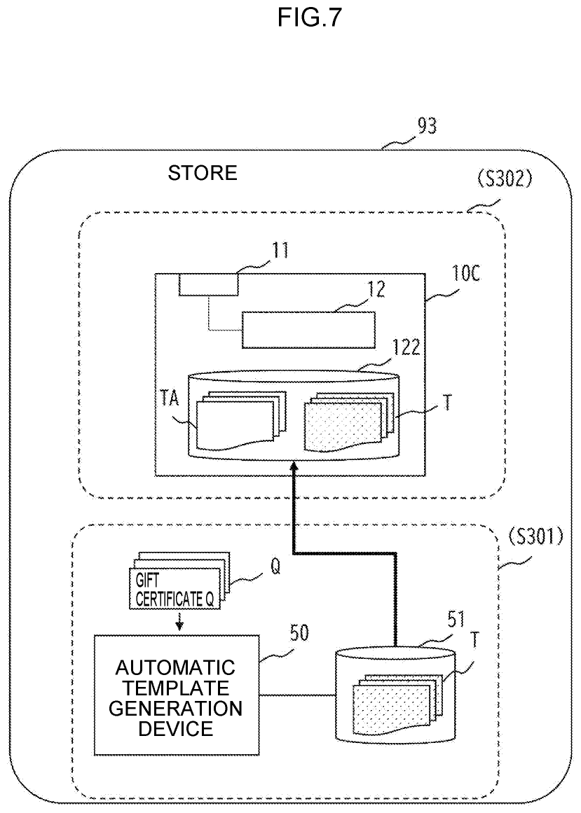

FIG. 7 is for explaining overall processing of the classification processing system 100A according to the second exemplary embodiment.

### S301: Master Template T Creation

In the store 93, the master template T employed to recognize the gift certificate Q is created by the automatic template generation device 50.

Say a new gift certificate Q is issued, and the store side is to be set up so as to be capable of handling the gift certificate Q. The store side introduces the gift certificates Q into the automatic template generation device 50.

The automatic template generation device 50 detects respective states of the introduced gift certificates Q and stores characteristic information of the gift certificates Q in the storage section 51. The automatic template generation device 50 employs the characteristic information of the gift certificates Q stored in the storage section 51 to generate the master template T for the gift certificates Q.

### S302: Master Template T Utilization

In the store, when the master template for the gift certificate Q has been generated, this master template T is installed in the cash processing device 10C, and the classification device 12 enables recognition processing to be performed on gift certificates using the master template T.

The gift certificate Q here does not need such a high level of security as for a banknote or the like, and so there is no need for the device vendor to assure the quality of the master template T. This means that the device vendor does not issue an authentication certificate PR file as in the first exemplary embodiment, and the store side handles the gift certificate Q based on their own responsibility.

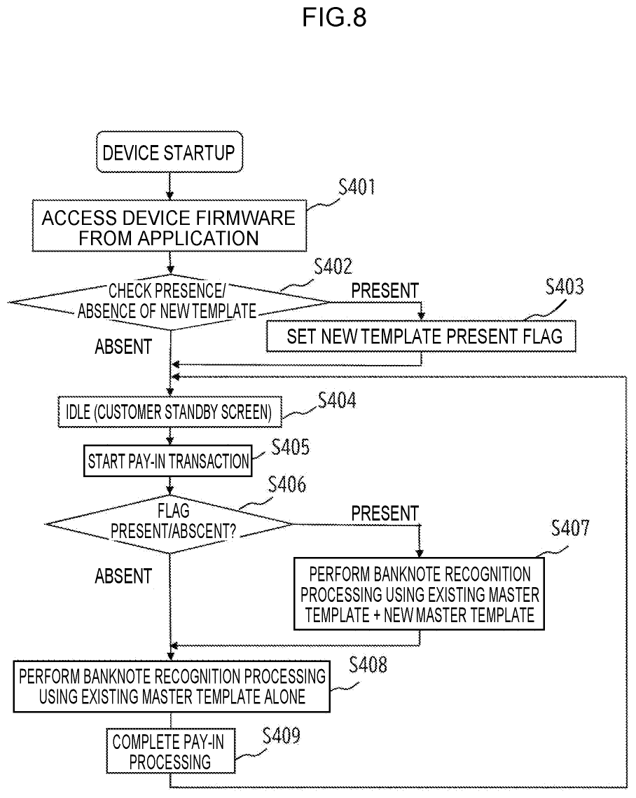

FIG. 8 is a flowchart illustrating an operation of pay-in processing in the cash processing device 10C according to the second exemplary embodiment.

Note that although an example is given here of a case in which processing using a master template T is performed for pay-in processing, transaction processing is not limited thereto, and there is applicability to sales money accounting processing, pay-out processing, audit processing, and the like.

After device startup of the cash processing device 10C, the device application accesses firmware of the device (S401), and the device application checks whether or not a new master template T corresponding to the gift certificate Q has been installed to the storage section (hard disk) 122 (S402).

In cases in which there is a new master template, the device application sets a new template flag indicating that use of the new master template is valid (S403), and after that processing transitions to S404. Note that processing transitions to S404 when there is no new master template T.

For example, the new template flag being “1” means that use of the new master template T is valid. On the other hand, the new template flag being “0” means that use of the new master template T is invalid.

At S404, as an idle state of the device application, the device application displays a customer standby reception screen on a display section, such as a display or the like of the cash processing device 10C (S404).

At this time, for example, the cash processing device 10C may display a screen on the display section to enable selection of a master template T, so as to enable selection by a store employee on the display section of the master template T to be used.

Moreover, for example, the cash processing device 10C may be configured so as to enable setting of setting information related to use of the master template T. For example, when a validity period of the gift certificate Q is set, such a validity period may be set as a validity period of the master template T. The cash processing device 10C may be configured so as not to allow the above master template T to be used when the set validity period has passed.

At S405, when the pay-in transaction starts (S405), the device application determines whether or not the new template flag is set (S406).

In cases in which the new template flag is set, the cash processing device 10C performs recognition processing on the gift certificate Q using the new master template T and the existing master template TA (S407). On the other hand, in cases in which the new template flag has not been set, the cash processing device 10C performs processing using the existing master template TA (S408).

Then when the pay-in transaction is complete (S409), the processing transitions to S404 and a return is made to the idle state.

### (B-3) Second Exemplary Embodiment Advantageous Effects

As described above, in the second exemplary embodiment, the store side is able to create the master template of the gift certificate independently, and processing on the gift certificate is enabled by saving this master template in the cash processing device. Namely, even in cases in which a gift certificate is issued for a short period of time, the store side is able to respond rapidly without leaving development of the master template up to the device vendor.

### (C) Other Exemplary Embodiments

Although various modified exemplary embodiments have been mentioned in the first and second exemplary embodiments, the present disclosure is also applicable to the following modified exemplary embodiments.

(C-1) Although an example has been given in which the banknote processing device 10 of the first exemplary embodiment is applied to a cash dispenser and an automated cash teller machine targeted toward a financial institution, there is no limitation thereto, and there is wide applicability to processing devices that perform banknote classification and is utilizable in, for example, a cash processing machine or the like that performs pay-in/pay-out of sales money in a retailer.

(C-2) In the first exemplary embodiment, a difference may be imparted to a classification operation in the banknote processing device 10 for cases in which the authentication certificate PR was confirmed and cases in which it was unable to be confirmed. Namely, a configuration may be adopted in which a classification operation provided by the device vendor is caused to be performed in cases in which the authentication certificate PR has been able to be confirmed. On the other hand in cases in which the authentication certificate PR has been confirmed, for example, classification operation may be permitted for 10 times only after device power has been switched ON, or, for example, the classification operation may be limited to classifying the banknotes one-by-one.

The entire content of the disclosure of Japanese Patent Application No. 2021-165294 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. A medium handling device comprising:
a storage means that stores a single or a plurality of medium recognition reference information;
a recognition means that uses the medium recognition reference information to recognize a state of a target medium; and
a setting means that, when medium recognition reference information that is new and authentication information corresponding to the new medium recognition reference information are stored in the storage means, sets use of the new medium recognition reference information as either valid or invalid, wherein
when the setting means has set valid, the recognition means uses the corresponding new medium recognition reference information to recognize a state of the medium.

2. A medium handling device comprising:
a storage means that stores a single or a plurality of medium recognition reference information;
a recognition means that uses the medium recognition reference information to recognize a state of a target medium; and
a setting means that, when medium recognition reference information that is new is stored in the storage means, sets use of the new medium recognition reference information as either valid or invalid, wherein
when the setting means has set valid, the recognition means uses the corresponding new medium recognition reference information to recognize a state of the medium.

3. The medium handling device of claim 1, wherein:
the setting means sets a new reference information flag to indicate whether or not use of the new medium recognition reference information is valid; and
the recognition means performs recognition processing using the corresponding new medium recognition reference information when the new reference information flag has been set valid.

4. (canceled)

5. (canceled)

6. A medium recognition reference information creation system comprising:
a first system including a first medium handling device and a reference information generation device; and
a second system that is separate to the first system and that includes a second medium handling device and an authentication device, wherein:
the reference information generation device of the first system detects characteristic information about introduced medium and generates medium recognition reference information for the medium; and
the second medium handling device of the second system uses the medium recognition reference information generated by the reference information generation device and the medium characteristic information to evaluate a quality of the medium recognition reference information;
the authentication device of the second system generates authentication information corresponding to the medium recognition reference information evaluated by the second medium handling device; and
the first medium handling device of the first system includes
a storage means that stores a single or a plurality of medium recognition reference information,
a recognition means that uses the medium recognition reference information to recognize a state of a target medium, and
a setting means that, when new medium recognition reference information that has been evaluated by the second medium handling device and authentication information corresponding to the new medium recognition reference information are stored in the storage means, sets use of the new medium recognition reference information as either valid or invalid, wherein
when the setting means has set valid, the recognition means uses the corresponding new medium recognition reference information to recognize a state of the medium.

7. The medium handling device of claim 2, wherein:
the setting means sets a new reference information flag to indicate whether or not use of the new medium recognition reference information is valid; and
the recognition means performs recognition processing using the corresponding new medium recognition reference information when the new reference information flag has been set valid.
